(19) United States
(12) Patent Application Publication
(10) Pub. No.: US 2025/0326067 A1
(43) Pub. Date: Oct. 23, 2025

(54) Welding Robot Checker

(71) Applicant: ALBAKSAN DIS TICARET VE PAZARLAMA A.S., Arnavutköy/Istanbul (TR)

(72) Inventor: Oguz Uzel, Besiktas/Istanbul (TR)

(73) Assignee: ALBAKSAN DIS TICARET VE PAZARLAMA A.S., Arnavutköy/Istanbul (TR)

(21) Appl. No.: 18/277,579

(22) PCT Filed: Sep. 20, 2022
(86) PCT No.: PCT/TR2022/051019

§ 371 Date: Aug. 16, 2023

(51) Int. Cl. B23K 31/12; B23K 11/11; B23K 37/02; B25J 11/00

(52) U.S. Cl. CPC B23K 31/125; B23K 37/0229; B25J 11/005; B23K 11/115; G05B 2219/45104

(57) ABSTRACT

The invention relates to the welding robot controller system, which will instantly check that the welding at each welding point in the resistance welding robot cells is performed according to the correct welding parameters and will instantly inform the robot and the operator in case of a nonconformity detection.

### TECHNICAL FIELD

The invention relates to the welding robot controller system, which will instantly check that the welding at each welding point in the resistance welding robot cells is performed according to the correct welding parameters and will instantly inform the robot and the operator in case of a nonconformity detection.

### BACKGROUND ART

Resistance spot welding is widely used in many industrial areas today, allowing two metals to be joined without any filler material and is used where a continuous welding nugget is not required. It is used more and more in robotic automation applications due to its fast cycle time, economical production process and connection of various materials. It is also one of the oldest welding techniques. In this welding technique, which is widely used particularly in the automotive industry, the parameters affecting the welding process include current value, welding time and electrode pressure force. It is aimed to create the desired core diameter with these welding parameters. Spot welding, also known as resistance welding, is a very convenient robotic welding application for sheet materials.

Spot welding has many advantages such as being a relatively clean and environmentally friendly process, an automated and easily applicable method, no need for filler metal, no open flames that can cause accidents and injuries, and the welding process not requiring an expert operator.

In spot welding robots, the welding program of each point on the parts to be welded is entered into the robot beforehand, and then the robot performs production process according to these inputs. The welding process is usually provided by a welding control unit that works in integration with the robot. This unit ensures that the previously entered welding current flows during the time entered into the unit. More than one program can be recorded in the unit. The robot starts the welding unit by calling a program from the unit for each welding point. Once the user has entered on the robot with which welding program each point will be welded and with which pressure force it will be welded, production continues without any instant verification control.

Welding errors such as loose spot, excess spot, burnt and porous spot, hard spot, spot with small core diameter, missing spot, loose spot cold adhesion occur in resistance spot welding.

In this way, production without instant verification control includes many faulty welding risks due to the possible reasons mentioned below.
The welding program numbers of some welding points can be changed later by the robot user incorrectly. A different welding program may cause inappropriate welding current and time to be applied for that spot.
The force values of some welding points can be changed incorrectly by the robot user.
Welding current and times can be changed in an uncontrolled way in the program contents on the welding control unit.
The current calibration of the welding control unit may be corrupted at any time.
The force calibration of the robot may be corrupted at any time.

Since production by robot is not under constant control, the robot will start faulty production from any moment of production process due to the factors mentioned above, and production may have been made in sizes that are very difficult to compensate until this is noticed.

In the document no. “TR2019/14199”, the invention is summerized as “it relates to a 4-axis welding robot that can weld to the desired point by moving in X, Y, Z and A axes including A axis part where the welding machine torch is attached, which ensures that the welding from the welding machine is transferred to the part to be welded, A axis shaft, which is connected to the welding machine torch by being attached to the said A axis part and enables the A axis to rotate, Z-axis carriage on which said A-axis part is attached, Z-axis ball screw, which enables the Z-axis carriage to move in the Z-axis, X axis carriage on which the Z axis carriage is installed, X-axis profile and X-axis ball screw, which enables the X-axis carriage to move in the X-axis, and Y axis counterforts placed opposite each other on the chassis by being attached to both ends of the mentioned X axis profile.”. The present application is about the welding robot, wherein there is no control mechanism when the robot is operating.

In the document no. “TR2021/01385”, the invention is summerized as “it relates to a resistance welding robot with an external power source with a welding module having an external power source that is flexible, lightweight and fast-running that enables faster welding processes and thus allows working in restricted areas, helically twisted circular section flexible conductor group that provides the transmission between the power source and the welding module and a movement mechanism that allows the upper copper gun group to move linearly, the upper steel group, which progresses depending on the lower steel group and forms the main construction group, the lower steel group, where the upper steel group receives support for movement and forms the lower construction group, a flexible apparatus that positions the lower copper gun group according to the welding point, tolerates the dimensional changes in the welding area, prevents the product on which the welding is performed from deforming, and provides the movement of the upper steel group, lower copper gun group, which high current passes for welding process and isolated from steel groups, upper copper gun group, which high current passes for welding process and is isolated from steel groups, linear carriage, which is the carrier car that provides on-off movement before and after the welding process.”. The present application is about the welding robot, wherein there is no control mechanism when the robot is operating.

Thus, the need to eliminate such shortcomings and disadvantages of the embodiments and practices employed in the prior art entails an improvement in the respective technical field.

### DESCRIPTION OF THE INVENTION

The present disclosure relates to a welding robot controller developed for eliminating the aforementioned disadvantages and providing new advantages to the respective technical field.

The purpose of the invention is to instantly monitor the factors affecting the welding, compare it with the typical correct values, and generate the signal that will immediately stop production in case of non-compliance, allowing early intervention. The invention does not allow production until necessary controls and corrections are made by authorized persons. The set values that should be present in our system are only entered and saved by the production welding authorities. After that, the incorrect interventions of robot programmers, maintainers, operators, etc. in the field to the programs of the robot or welding control units in the cell will be under control.

Another purpose of the invention is to archive the data instantly in the database in the cloud or local server and to provide reporting to the users.

### BRIEF DESCRIPTION OF DRAWINGS

The embodiments of the present disclosure which are summarized above and discussed in more detail below can be better understood by referring to exemplary embodiments of the present disclosure illustrated in the accompanying drawings. It should be noted, however, that the accompanying drawings only describe the typical embodiments of the present disclosure, and thus, are not to be considered as limiting the scope of the present disclosure such that other effective embodiments may also be within the scope of the present disclosure.

For ease of understanding, identical reference numerals are used where possible to indicate identical elements in the figures. Figures are not drawn to scale and can be simplified for clarity. It is contemplated that elements and features of an embodiment can be usefully incorporated into other embodiments without the need for further explanation.

FIG. 1: A schematic view of the present invention.

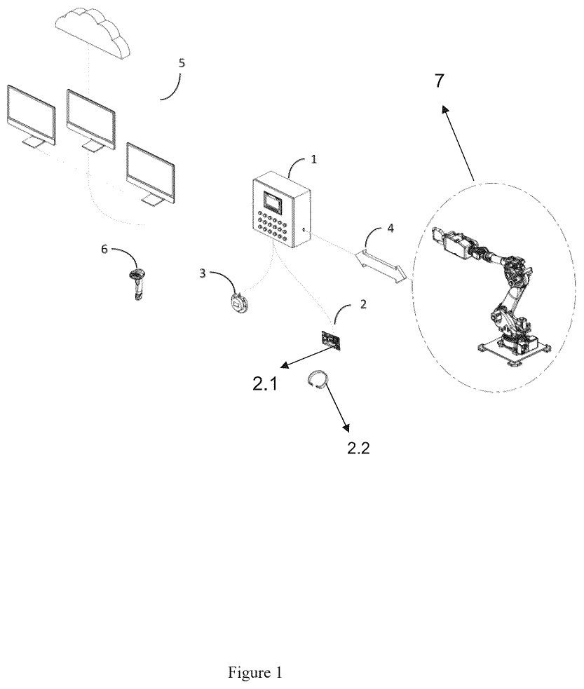

### DESCRIPTION OF DETAILS IN DRAWINGS

Described herein are the reference numbers shown in the figures.
1—Checker Control Unit
2—Current Reading Module
2.1—MicroController Based Current Reading Board
2.2—Toroidal Current Coil
3—Force Calibration Module (loadcell)
4—Serial and digital communication system with robot
5—Data transfer to cloud or local server
6—Barcode/QR-Code Reading Module
7—Spot Robot Cell

### DETAILED DESCRIPTION OF THE INVENTION

The preferred alternatives of the embodiments of invention, which are mentioned in this detailed description, are only intended for providing a better understanding of the subject-matter, and should not be construed in any restrictive sense.

The invention relates to the welding robot controller system/device, which will instantly check that the welding at each welding point in the resistance welding/spot robot cells (7) is performed according to the correct welding parameters and will instantly inform the robot and the operator in case of a nonconformity detection.

Production values that the system keeps under control:
Reading the instant welding current and time individually for each spot point and checking it with the set value,
Receiving the instant welding force individually for each spot point from the robot via serial communication and checking it with the set value,
Receiving the instant welding program individually for each spot point from the robot via serial communication and checking it with the set value,
Reading the individual code of each part in production process with a barcode/QR-code reader and matching it with the actual resource values, sending it to the cloud or local server,
Measuring the robot force over a determined force value by means of the loadcell at certain periods and informing whether there is a need for calibration or not.

The table of information to be audited and recorded is as follows. The SET values here will be entered by the production authority.

| | | | Welding | | Welding | | Welding | | Force | |
|---|---|---|---|---|---|---|---|---|---|---|
| Reference | Part Unique | Spot | Program No. | | Current [kA] | | Time [ms] | | [daN] | |
| No. | ID Code | No. | SET | ACTUAL | SET | ACTUAL | SET | ACTUAL | SET | ACTUAL |
| RH1822BA | 20220802M103 | 1 | 3 | 3 | 12.5 | 12.3 | 200 | 200 | 450 | 448 |
| RH1822BA | 20220802M104 | 2 | 7 | 7 | 10 | 10.2 | 220 | 220 | 400 | 402 |
| RH1822BA | 20220802M105 | 3 | 4 | 4 | 15.4 | 15.5 | 250 | 250 | 500 | 502 |
| RH1822BA | 20220802M106 | 4 | 3 | 3 | 12.5 | 12.6 | 200 | 200 | 450 | 447 |
| RH1822BA | 20220802M107 | 5 | 1 | 1 | 9 | 9.1 | 150 | 154 | 400 | 405 |

The invention includes at least one Checker Control Unit (1), which is the unit with hardware and software where all data in the controller system is evaluated and controlled, at least one Current Reading Module (2), which is the module that will instantly read the welding current and time with high resolution and speed, calculate the RMS value and send it to the controller unit via serial communication, at least one Force Calibration Module (3), which is the module that will measure the force between the load cell and the robot upper and lower electrodes and transfer the measurement value to the controller unit analogously
the controller checker control unit (1) receives some instant data such as the welding program which is run on the robot controls, spot number etc. by serial or digital communication system-, similarly, at least one serial and digital communication system (3) with Robot, which informs the robot in case of proper welding or unproper welding,
at least one Barcode/QR-Code Reading Module (6), which is the module that will read the individual code on the part to be welded in production process and transfer it to the controller unit,

Instant data obtained by the controller checker control unit (1) includes data transfer to at least one Cloud or local server (5), where it is transferred to a defined area on the cloud or local server for archiving, analysis and reporting.

### Method of Practice of the Invention:

It starts with entering the welding current, time, welding program and force values for each point by the production authority on the device and recording them in the formula.

Only the set values entered by the authorized person will be controlled with the instantaneous ones during production. Thus, process parameters can only be determined by authorized persons.
With the current reading probes and microcontroller-based fast analog signal processing board, the welding current and time will be directly and instantly read individually for each spot, independently of the robot, and instantly compared with the set value.

If the actual value and the set value are out of tolerance, a stop information will be sent to the robot instantly and erroneous continuation of production will be prevented.
The actual welding program number and the set welding program number for each spot coming from the robot will be instantly compared.
If a different welding program is run for each spot, this situation will be detected instantly and stop information will be sent to the robot.
The actual welding force and the set welding force for each spot coming from the robot will be instantly compared.

If a different welding force occurs for each spot, this situation will be detected instantly and stop information will be sent to the robot.
Since the welding current set value and the actual value are compared at each spot, current calibration control is performed instantly.

If the current calibration is disturbed at any time, this will be detected immediately at the first spot. Thus, even if periodic current calibration is carried out manually in the enterprise, the production of welded parts with faulty current between periods will be prevented.
Selecting the reference formula to be welded

The formula number of which part is produced in the Spot Robot cell (7) will be sent to our device from the robot. The formula information stored in the device will be activated.
Reading barcode/QR-code containing instant part individual code to be welded

The instantaneous current, time and force values are read for each welding point on the part and sent to the archive with the relevant part label.
Archiving and reporting of read values and comparisons

During system instant controls, the comparison results of the current, time, force, welding programs and set values associated with the reference definition, the individual code of each produced part, the sequence/identification label of each spot can be archived on the server, and reports for users can be generated.
With the help of the force measuring probe connected to the system, the robot will perform the force calibration control of the welding pliers at certain intervals.

Differences between the force value entered on the robot and the actual force value will be controlled by periodic controls. For example, when the robot applies pressure to the probes with a certain force at the beginning of the shift, our device will check the accuracy of this and give information.

1—Checker Control Unit (1): There is a touch screen and PLC modules in the checker control unit (1). Parameter entries, formula recording, instant status monitoring and alarm displaying can be done via the touch screen. The control algorithm of the system is programmed with PLC. In addition, digital input/output and analog signal reading are performed with PLC modules.

2—Current Reading Module (2): It consists of microcontroller based electronic board and toroidal coil for current reading. The toroidal coil robot welding pliers with a conversion rate of 150 mV/KA are placed in the secondary circuit and its cable is connected to the microcontroller board placed in the main panel. The resistance welding current is sampled at a rate of 10,000 samples/s, and the instant and RMS values and duration of the actual current are read. The read values are instantly transferred to the PLC via ethernet cable.

3—Force Calibration Module (3): This module provides the reading of the force generated by the robot pliers on a loadcell by closing the lower and upper electrodes. It is checked that the read force value and the predefined force value applied by the robot are equal within the tolerance. If it is out of tolerance, the system reports the need for force calibration on the robot side.

4—Communication system with the robot: Information such as formula number, welding program number and ready/error information can be communicated between the robot and the control system via digital input and output channels.

In addition, more information will be transferred through ethernet-based serial communication between the robot and the control system. Formula number, welding program and ready/error information can be created on serial communication, as well as data created on the robot side, such as instantaneous force information, are sent to the control system via serial communication system.

5—Barcode/QR-code reading module (6): It consists of a barcode/2d-code reading device. The individual barcode/2d-code that is pre-written on the part loaded into the Spot Robot cell (7) and that identifies the part is read with this device. The individual code read and the data read during the production of the part are matched and sent to the server or the cloud. In this way, part-based production record can be made, monitored and reported retrospectively. In addition, if there was an information that the part that came to the robot cell was unproper as regards to its previous processes, this information can be read from the recorded information on the server and the robot can be prevented from starting the process with an unproper part.

6—Data transfer to cloud or local server (5): Instant data obtained by the controller checker control unit (1) are transferred to a defined area on the cloud or local server for archiving, analysis and reporting.

The device of our invention will also communicate with the robot electrode and adapter uniformity measurement systems via mechanical probe or optically and provide that this information is also kept under control.

1- A method for welding robot controller system, which will instantly check that the welding at each welding point in the resistance welding robot cells is performed according to the correct welding parameters and will instantly inform the robot and the operator in case of a nonconformity detection, characterized in that it includes the following process steps:
Entering the welding current, time, welding program and force values for each point by the production authority on the device and recording them in the formula,
With the current reading probes and microcontroller-based fast analog signal processing board, directly and instantly reading the welding current and time individually for each spot, independently of the robot, and instantly comparing with the set value,
If the actual value and the set value are out of tolerance, sending a stop information to the robot instantly and preventing erroneous continuation of production,
Instantly comparing the actual welding program number and the set welding program number for each spot coming from the robot,
If a different welding program is run for each spot, detecting instantly this situation and sending stop information to the robot,
Instantly comparing the actual welding force and the set welding force for each spot coming from the robot,
If a different welding force occurs for each spot, sending this situation will be detected instantly and stop information to the robot,
Since the welding current set value and the actual value are compared at each spot, performing current calibration control instantly,
If the current calibration is disturbed at any time, detecting it immediately at the first spot, thus preventing the production of welded parts with faulty current between periodic current calibration processes,
Selecting the reference formula to be welded,
Sending the formula number of which part is produced in the Spot Robot cell (7) to our device from the robot, and activating the formula information stored in the device,
Reading barcode/QR-code containing instant part individual code to be welded,
Reading the instantaneous current, time and force values for each welding point on the part and sending to the archive with the relevant individual part label.
Archiving and reporting of read values and comparisons,
During system instant controls, archiving the comparison results of the current, time, force, welding programs and set values associated with the reference definition, the individual code of each produced part, the sequence/identification label of each spot on the server, and generating reports for users,
With the help of a load cell-based force measuring probe connected to the system, performing the force calibration control of the welding pliers at certain intervals by the robot,
Taking the differences between the force value entered on the robot and the actual force value under control with periodic controls, when the robot applies pressure to the load cell with a certain force at the beginning of the shift, checking its accuracy and giving information by the device.

2- A welding robot controller system/device, which will instantly check that the welding at each welding point in the resistance welding robot cells is performed according to the correct welding parameters and will instantly inform the robot and the operator in case of a nonconformity detection, characterized in that it includes:
at least one Checker Control Unit (1), which is the unit with hardware and software where all data in the controller system is evaluated and controlled,
at least one Current Reading Module (2), which is the module that will instantly read the welding current and time with high resolution and speed, calculate the RMS value and send it to the controller unit via serial communication,
at least one Force Calibration Module (3), which is the module that will measure the force between the load cell and the robot upper and lower electrodes and transfer the measurement value to the controller unit analogously,
at least one serial and digital communication system (4) with Robot, which provides communication between Robot and control system and gives information such as formula number, ready/error information to the robot in case of proper welding or unproper welding,
At least one data transfer system (5) to Cloud or local server where instant data obtained by the controller control unit (1) is transferred for archiving, analysis and reporting,
at least one Barcode/QR-Code Reading Module (6), which is the module that will read the individual code on the part to be welded in production process and transfer it to the controller unit.

3- Checker Control Unit according to claim 2, which is the unit with hardware and software where all data in the controller system is evaluated and controlled, characterized in that it includes
At least one touch screen that allows the device to enter parameter entries, formula record, instant status monitoring and alarm displaying,
at least one PLC module, in which the control algorithm of the system is programmed, as well as digital input/output and analog signal reading can be performed.

4- Current Reading Module (2) according to claim 2, which will instantly read the welding current and time with high resolution and speed, calculate the RMS value and send it to the controller unit via serial communication, characterized in that it consists of at least one MicroController Based Current Reading Board (2.1) and at least one toroidal current coil (2.2) for current reading.

5- The application method of the current application module according to claim 1, characterized in that it consists of the following process steps:
Preferably placing the toroidal coil with a conversion rate of 150 mV/kA into the secondary circuit of the robot welding pliers,
Connecting the microcontroller board, the cable of which is placed in the main panel, sampling the resistance welding current preferably at a rate of 10,000 samples/sec and reading the instantaneous value and RMS value and time of the actual current,
instantly transferring the read values to the PLC via ethernet cable.

6- The application method of the Force Calibration Module according to claim 1, characterized in that it includes the following process steps:
Providing the reading of the force generated by the robot pliers on a loadcell by closing the lower and upper electrodes,
Checking that the read force value and the predefined force value applied by the robot are equal within the tolerance,
If it is out of tolerance, reporting the need for force calibration on the robot side by the system.

7- Barcode/QR-Code Reading Module (6) according to claim 2, which will read the individual code on the part to be welded in production process and transfer it to the controller unit, characterized in that it consists of at least one barcode/2d-code reading device, which reads the individual barcode/2d-code that is pre-written on the part loaded into the spot robot cell (7) and that defines the part, and PLC module.

8- A method for Barcode/QR-Code Reading Module, which will read the individual code on the part to be welded in production process and transfer it to the controller unit, characterized in that it includes
Reading the individual barcode/2d-code that is pre-written on the part loaded into the Spot Robot cell (7) and that identifies the part,
Matching the individual code read and the data read during the production of the part and sending to the server or the cloud,
In this way, making part-based production record, monitoring and reporting retrospectively.

9- The welding robot controller system according to claim 2, which will instantly check that the welding at each welding point in the resistance welding robot cells is performed according to the correct welding parameters and will instantly inform the robot and the operator in case of a nonconformity detection, characterized in that it includes at least one force measuring probe that helps the robot welding pliers to perform force calibration control at certain periods.

10- The welding robot controller system according to claim 2, which will instantly check that the welding at each welding point in the resistance welding robot cells is performed according to the correct welding parameters and will instantly inform the robot and the operator in case of a nonconformity detection, characterized in that it includes at least one current reading probe, which allows directly and instantly reading the welding current and time individually for each spot, independently of the robot, and instantly comparing with the set value.
